(19) United States
(12) Patent Application Publication
(10) Pub. No.: US 2014/0089884 A1
(43) Pub. Date: Mar. 27, 2014

(54) DESIGN SUPPORT METHOD AND APPARATUS

(71) Applicant: Fujitsu Limited, Kawasaki-shi (JP)

(72) Inventor: Kiyoshi IKENISHI, Yokohama (JP)

(21) Appl. No.: 13/939,630

(22) Filed: Jul. 11, 2013

(30) Foreign Application Priority Data
Sep. 26, 2012 (JP) 2012-212037

(51) Int. Cl. G06F 17/50

(52) U.S. Cl. CPC G06F 17/5077
USPC 716/127

(57) ABSTRACT

A disclosed design support method includes: dividing an circuit element that is included in a circuit to be designed and is provided on a path that connects between memory circuits into plural circuit elements, based on information concerning circuit elements that can be divided into circuit elements; tracing the path from the memory circuits; and during the tracing, setting a new power supply voltage that is lowed by a predetermined voltage from a voltage, which was set immediately before, to a traced circuit element, which is provided on the path and satisfies a predetermined condition concerning a predetermined lower limit voltage of the traced circuit element.

### CROSS-REFERENCE TO RELATED APPLICATIONS

This application is based upon and claims the benefit of priority of the prior Japanese Patent Application No. 2012-212037, filed on Sep. 26, 2012, the entire contents of which are incorporated herein by reference.

### FIELD

This invention relates to a method and apparatus for supporting circuit design.

### BACKGROUND

Conventionally, in a Large Scale Integration (LSI), a memory circuit such as a Random Access Memory (RAM), latch, flip flop or register restricts an operational lower-limit voltage of the LSI, and in case of a single power voltage, in other words, in case where the same voltage is supplied to all circuits included in the LSI, it is impossible to lower the voltage to a voltage that is less than the operational lower-limit voltage determined by the memory circuit and the like.

Therefore, in order to reduce the power consumption, a power supply voltage for combinational circuits other than the memory circuit is separated from a power supply voltage for the memory circuit instead of the single power voltage, and the power voltage for the combinational circuits are lowered than the power voltage for the memory circuit. However, a level sifter is inserted at a boundary between the memory circuit and the combinational circuits.

For example, in case where registers are used as an example of the memory circuit, it is assumed that the operational lower-limit voltage of the register is 0.7V, and the operational lower-limit voltage of the combinational circuits other than the registers is 0.5V. When the level shifter is not used, 0.7V is set as both of the power supply voltages for the registers and the combinational circuits, in case of the low-voltage and low-frequency operation, as illustrated in FIG. 1. In the circuit in FIG. 1, registers illustrated at the left and right edges by rectangles are provided, combinational circuits (including NAND circuit, AND circuit, NOT circuit, OR circuit, and the like) are provided between them. Moreover, in case of the high-voltage and high-frequency operation, as illustrated in FIG. 2, 0.9V is set as the power supply voltage for the registers and the combinational circuits. Although the operational lower-limit voltage for the combinational circuits other than the registers is 0.5V, 0.5V cannot be set as the power supply voltage for the combinational circuits.

Then, as illustrated in FIG. 3, level shifters 1000 are inserted at the boundary between the left-edge registers and the combinational circuits, and the level shifters 1100 are inserted at the boundary between the right-edge registers and the combinational circuits. Then, in case of the low-voltage and low-frequency operation, the power supply voltage of 0.7V is supplied to the register side, and the power supply voltage of 0.5V is supplied to the combinational circuit side. It is possible to lower the power supply voltage of the combinational circuits than the registers, thereby it is possible to reduce the power consumption.

On the other hand, in case where the level shifters are used, when the power supply voltage of 0.9V is supplied to both of the registers and the combinational circuits in the high-voltage and high-frequency operation as illustrated in FIG. 4, delays by the level shifters 1000 and 1100 increase regardless of the high-speed operation being desired.

Therefore, it is desired that the level shifters are not used. However, there is no method that is appropriate for a Dynamic Voltage and Frequency Scaling control, for example, in which the power supply voltage and frequency are increased when the processing load is high, and the power supply voltage and frequency are decreased when the processing load is low.

### SUMMARY

A design support method relating to this invention includes: (A) dividing an circuit element that is included in a circuit to be designed and is provided on a path that connects between memory circuits into plural circuit elements, based on information concerning circuit elements that can be divided into circuit elements; (B) tracing the path from the memory circuits; and (C) during the tracing, setting a new power supply voltage that is lowed by a predetermined voltage from a voltage, which was set immediately before, to a traced circuit element, which is provided on the path and satisfies a predetermined condition concerning a predetermined lower limit voltage of the traced circuit element.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting an example of voltage setting in case where no level shifter is used in case of low-voltage and low-frequency operation;

FIG. 2 is a diagram depicting an example of voltage setting in case where no level shifter is used in case of high-voltage and high-frequency operation;

FIG. 3 is a diagram depicting an example of voltage setting in case where level shifters are used in case of the low-voltage and low-frequency operation;

FIG. 4 is a diagram depicting an example of voltage setting in case where level shifters are used in case of high-voltage and high-frequency operation;

FIG. 5 is a functional block diagram of a design support apparatus relating to an embodiment of this invention;

FIG. 6 is a diagram depicting a processing flow of this embodiment;

FIG. 7 is a diagram depicting an OR circuit represented by FETs;

FIG. 8 is a diagram depicting a cell division example of the OR circuit;

FIG. 9 is a diagram depicting a combinational circuit represented by FETs;

FIG. 10 is a diagram depicting a cell division example of the combinational circuit;

FIG. 11 is a diagram depicting a layout configuration example in case of performing the cell division;

FIG. 12 is a diagram depicting examples (a) to (d) of a cell division rule;

FIG. 13 is a diagram depicting a specific example of a circuit;

FIG. 14 is a diagram depicting an example of a circuit after the cell division;

FIG. 15 is a diagram to explain a setting method of voltages lowered each tracing of one cell;

FIG. 16 is a diagram to explain a setting method of voltages lowered each tracing of one cell;

FIG. 17 is a diagram to explain a first stage in a voltage setting processing;

FIG. 18 is a diagram to explain a second stage in the voltage setting processing;

FIG. 19 is a diagram to explain a third stage in the voltage setting processing;

FIG. 20 is a diagram to explain a fourth stage in the voltage setting processing;

FIG. 21 is a diagram to explain critical paths and non-critical paths;

FIG. 22 is a diagram depicting a processing flow relating to this embodiment;

FIG. 23 is a diagram depicting a circuit example in case of inserting inverters;

FIG. 24 is a diagram to explain a first stage in the power supply setting processing executed for a circuit example after inserting the inverters;

FIG. 25 is a diagram to explain a second stage in the power supply setting processing executed for the circuit example after inserting the inverters;

FIG. 26 is a diagram to explain a third stage in the power supply setting processing executed for the circuit example after inserting the inverters;

FIG. 27 is a diagram to explain a fourth stage in the power supply setting processing executed for the circuit example after inserting the inverters;

FIG. 28 is a diagram depicting a variation for the insertion of the inverters;

FIG. 29 is a diagram depicting a variation for the insertion of the inverters;

FIG. 30 is a diagram depicting a variation for the insertion of the inverters;

FIG. 31 is a diagram depicting an example of a power supply voltage setting in case where the cell division is not carried out;

FIG. 32 is a diagram depicting a classification example according to the power supply voltages of the cells and sub-cells;

FIG. 33 is a diagram depicting an example of a temporal change of the power supply voltages and operational frequency;

FIG. 34 is a diagram to explain an element division in case of including RAM; and

FIG. 35 is a functional block diagram of a computer.

### DESCRIPTION OF EMBODIMENTS

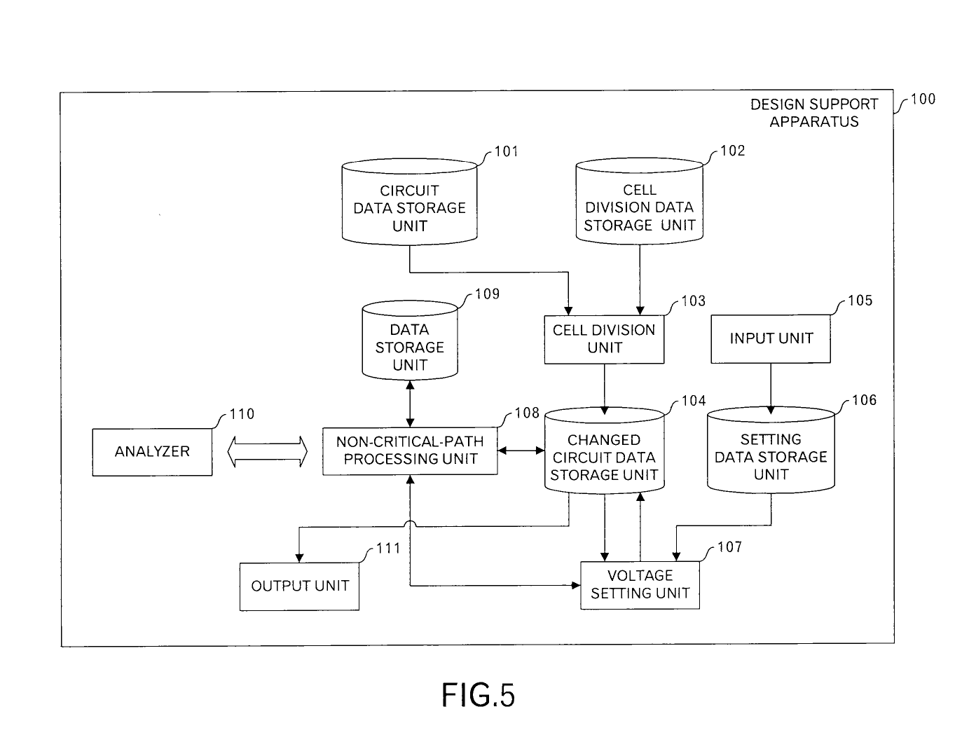

FIG. 5 illustrates a functional block diagram of a design support apparatus 100 that relates to an embodiment of this invention. The design support apparatus 100 includes a circuit data storage unit 101, a cell division data storage unit 102, a cell division unit 103, a changed circuit data storage unit 104, an input unit 105, a setting data storage unit 106, a voltage setting unit 107, non-critical-path processing unit 108, a data storage unit 109, an analyzer 110 and an output unit 111.

Data that is used in a following processing (e.g. data of netlist that defines connection information of circuits and the like) is stored in the circuit data storage unit 101. The cell division data storage unit 102 stores data for cells (circuit elements) that can be divided by connecting to different power supply lines. The cell division unit 103 performs a cell division processing for data of the circuits, which is stored in the circuit data storage unit 101, by using data for cells that can be divided, which is stored in the cell division data storage unit 102, and stores processing results into the changed circuit data storage unit 104. The input unit 105 accepts inputs of various setting data from a user, and stores the input data into the setting data storage unit 106.

The voltage setting unit 107 performs a voltage setting processing for the changed circuit data stored in the changed circuit data storage unit 104 according to the setting data stored in the setting data storage unit 106, and stores processing results into the changed circuit data storage unit 104.

Moreover, the non-critical-path processing unit 108 cooperates with the voltage setting unit 107 and the analyzer 110 that estimates delays and consumed power to set power supply voltages in order to further reduce the consumed power by adding changes to the non-critical paths in the changed circuit, which is stored in the changed circuit data storage unit 104. At that time, the non-critical-path processing unit 108 stores data during the processing into the data storage unit 109. Here, the “critical path” is a path between memory circuits (e.g. RAM, register, latch, flip flop or the like), in which its delay value exceeds a permissible delay value that is a reciprocal of the maximum operable frequency of an LSI that include circuits to be designed. Moreover, the “non-critical path” is a path between memory circuits, which has a margin in the delay value with respect to the permissible delay value.

The analyzer 110 is a module that estimates a delay and the consumed power and has already been existed, and is realized, for example, by a delay analysis program or the like. In this embodiment, an existing delay analysis program or the like is used. Therefore, any further explanation is omitted in this embodiment. Moreover, the analyzer 110 may be included in the design support apparatus 100, or may be implemented in another computer connected through a network with the design support apparatus 100.

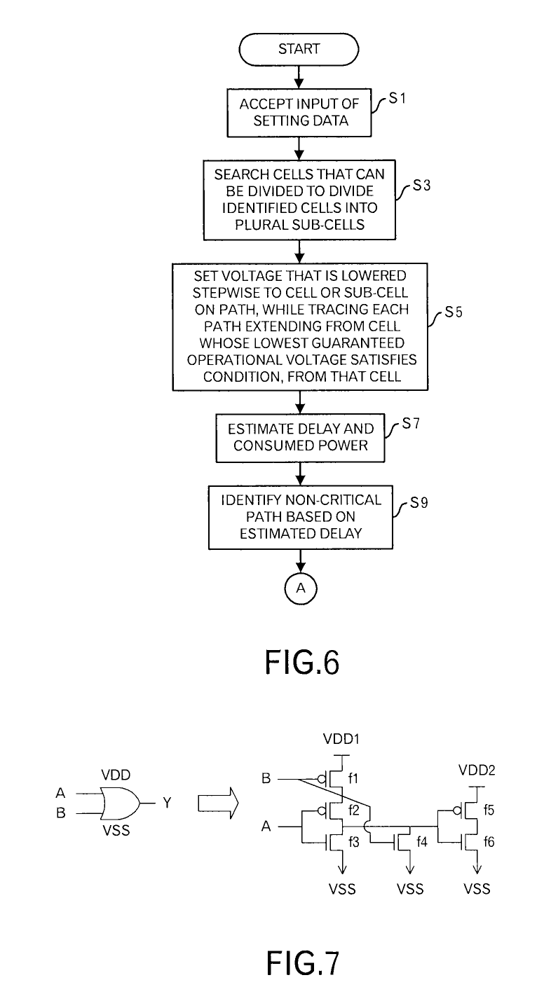

Next, processing contents of the design support apparatus 100 will be explained by using FIGS. 6 to 34. The input unit 105 accepts inputs of data used in the voltage setting unit 107 from the user (e.g. voltage width that is lowered for each tracing a cell included in combinational circuits on a path that is a route that connects between registers, data for the lowest guaranteed operational voltage of each type of cells and the like), and stores the inputted data into the setting data storage unit 106 (FIG. 6: step S1).

Then, the cell division unit 103 searches the circuit data stored in the circuit data storage unit 101 for cells that can be divided by using data concerning cells that can be divided or split, which is stored in the cell division data storage unit 102, and when the cell that can be divided is detected, the cell division unit 103 divides the cell that can be divided into plural predetermined sub-cells, and stores the changed circuit data into the changed circuit data storage unit 104 (step S3).

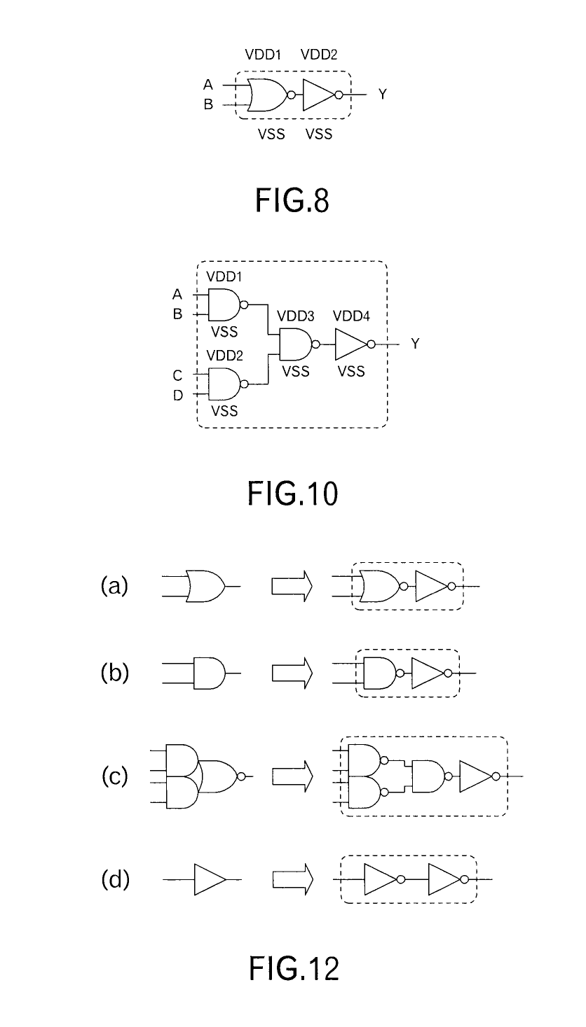

The cell represents a minimum unit of a circuit element that is handled in the layout in the design process of the LSI. The cell is obtained by combining several Field Effect Transistors (FETs), and corresponds to a single function such as a flip flop, AND logic or the like. For example, in case of an OR circuit as illustrated in the left of FIG. 7, an OR operation result of inputs A and B is outputted from an output Y. In this OR circuit, a current flows from a power supply line VDD to a power supply line VSS. This OR circuit is represented by FETs as illustrated in the right of FIG. 7. Because no current flows between a drain electrode and a gate electrode, between a source electrode and a gate electrode, except for leakage currents, it is possible to split the circuit at appropriate gate electrodes. In other words, when FETs f1 to f4 in the first half are separated from FETs f5 and f6 in the second half, it becomes possible to use different power supply lines VDD1 and VDD2 for the power supply line VDD. For example, when the OR circuit illustrated in FIG. 7 is equivalently divided into a NOR circuit including the FETs f1 to f4 and an inverter including FETs f5 and f6 as illustrated in FIG. 8, two kinds of power supply voltages can be applied by using two power supply voltages.

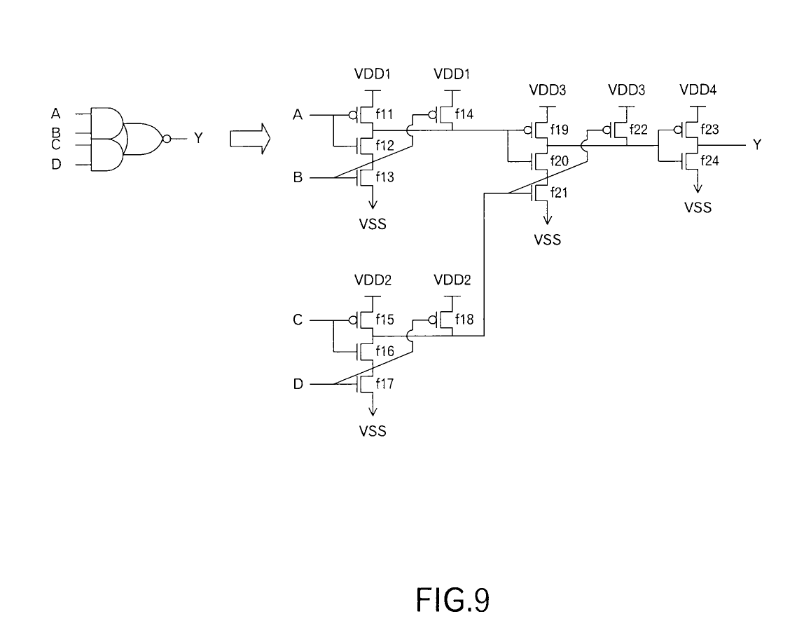

Moreover, an AND-NOR circuit that is a combinational circuit that combines two ANDs and one NOR as illustrated in the left of FIG. 9 can be divided into 4 FET groups as illustrated in the right of FIG. 9. In other words, the first group corresponds to FETs f11 to f14, which relate to VDD1, the second group corresponds to FETs f15 to f18, which relate to VDD2, the third group corresponds to FETs f19 to f22, which relate to VDD3, and the fourth group corresponds to FETs f23 and f24, which relate to VDD4. Therefore, as illustrated in FIG. 10, the AND-NOR circuit is equivalently divided into three NANDs and one inverter.

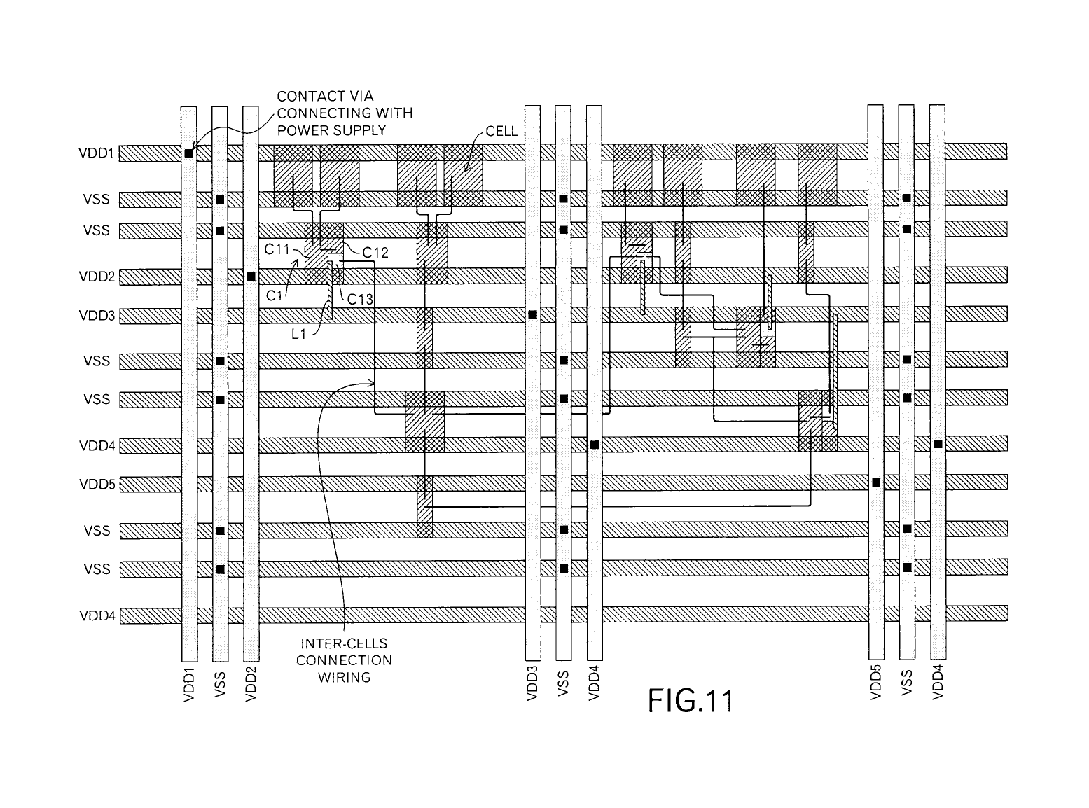

Thus, in case of the cell division, the layout on the LSI can actually be formed as schematically illustrated in FIG. 11. In an example of FIG. 11, three sets of three power supply lines extending in the vertical direction, power supply lines that connect through a power supply line contact via with that vertical power supply line and extends in the horizontal direction, plural cells provided between the horizontal power supply lines, and inter-cells connecting wirings that connect plural cells are included. For example, cell C1 is a cell connected to the power supply lines VDD2 and VSS, and is divided by the cell division into sub-cells C11 and C12 that are connected with the power supply line VDD2 and a sub-cell C13 that is connected through a line L1 with the power supply line VDD3. Thus, by providing a power supply line such as the power supply line L1, it is possible to supply the power supply voltage for the sub-cell appropriately.

As described above, a rule to divide one cell into plural sub-cells for which the power supply can be split is stored in the cell division data storage unit 102 in advance. For example, as illustrated in FIG. 12, a cell to be searched, which is illustrated in the left, is associated with sub-cell configuration after the division, which is illustrated in the right. Here, four examples of (a) to (d) are illustrated, however, the number is not restricted, and plural types of cells for which the power supply can be separated in advance are associated with the sub-cell configuration after the division. At the step S3, the cells in the left of FIG. 12 are searched, and when detected, the detected cell is replaced with an associated sub-cell configuration in the right to perform the cell division.

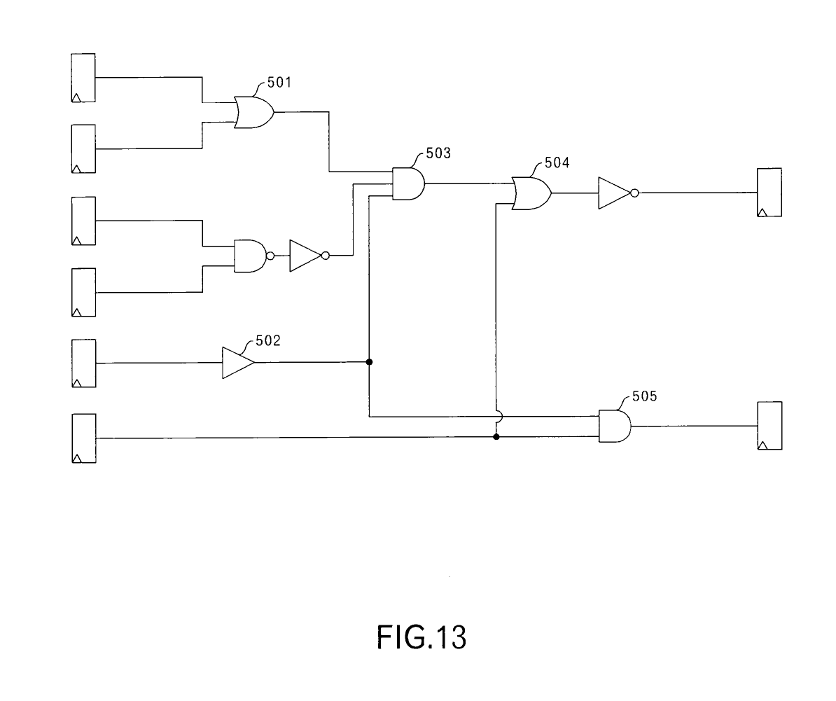

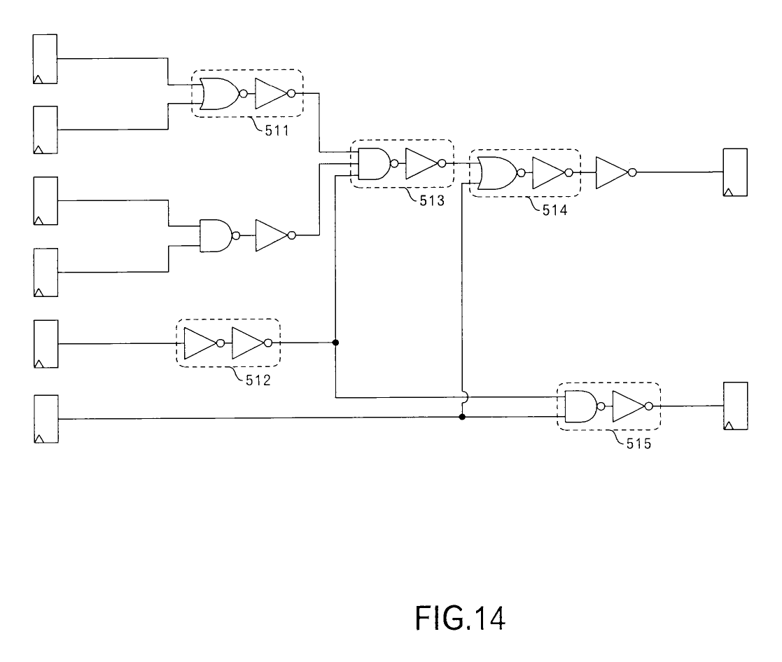

For example, when a processing is carried out for a circuit illustrated in FIG. 13, the circuit illustrated in FIG. 13 is converted into a circuit illustrated in FIG. 14, by replacing cells 501 to 505 in combinational circuits between registers in the left edge (latch, flip flop or the like) and registers in the right edge with equivalent logic circuits respectively configured by plural sub-cells based on data of cells that can be divided and are stored in the cell division data storage unit 102. In an example of FIG. 14, OR circuit 501 is replaced with a serially-connected elements 511 including a NOR circuit and inverter, a buffer 502 is replaced with a serially-connected elements 512 including two inverters, an AND circuit 503 is replaced with a serially-connected elements 513 including a NAND circuit and inverter, an OR circuit 504 is replaced with a serially-connected elements 514 including a NOR circuit and inverter, and an AND circuit 505 is replaced with a serially-connected elements 515 including a NAND circuit and inverter.

Next, the voltage setting unit 107 sets a voltage that is lowered stepwise for each of cells and sub-cells on a path, according to the setting data stored in the setting data storage unit 106 for the changed circuit data stored in the changed circuit data storage unit 104, while tracing each path extending from a cell whose lowest guaranteed operational voltage satisfies a predetermined condition from that cell (step S5).

The cell whose lowest guaranteed operational voltage satisfies the predetermined condition is a cell that has the lowest guaranteed operational voltage higher than the lowest guaranteed operational voltage of the combinational circuits, for example. For example, the lowest guaranteed operational voltage of the combinational circuits is 0.5V, and when the lowest guaranteed operational voltage of the register is 0.7V, the register is a cell that satisfies the predetermined condition. When both of the RAM whose lowest guaranteed operational voltage is 0.8V and register whose lowest guaranteed operational voltage is 0.7V are included, both of the register and RAM are cells that satisfy the predetermined condition.

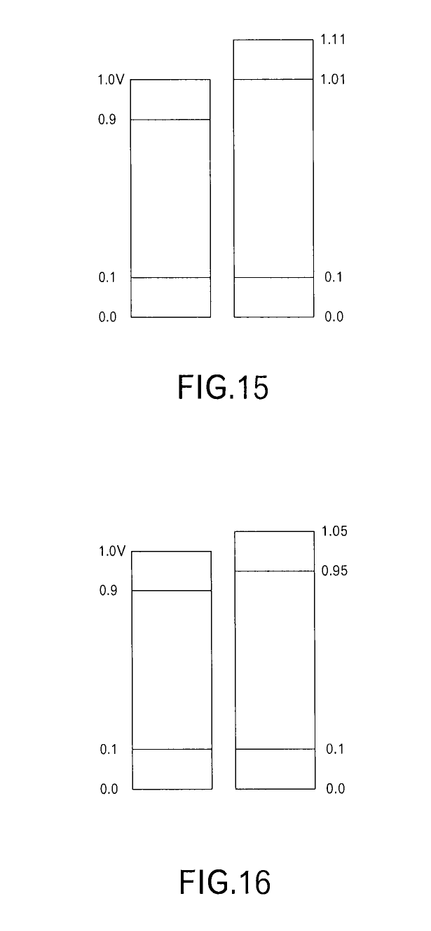

In the circuit example in FIG. 14, the registers at both of the left edge and right edge are cells that satisfy the predetermined condition. Then, in case where a path is traced, when tracing toward one next cell or sub-cell, a voltage that is lowered by a designated voltage width is set. The designated voltage width is set by a user, for example, under a following consideration. In other words, a voltage that is less than a difference between the power supply voltage and a threshold voltage by which an input voltage is determined as being “high” is set. More specifically, when the difference between the power supply voltage and the threshold voltage is 0.1V, 0.05V is used as the designated voltage width, for example. As illustrated in the left of FIG. 15, the power supply voltage is 1.0V at the cell of the previous stage, and the input voltage that is equal to or higher than 0.9V is determined as being “high” at the cell of the previous stage. At the cell of the previous stage, an input voltage that is equal to or lower than 0.1V is determined as being “low”. On the other hand, as illustrated in the right side of FIG. 15, a power supply voltage 1.11V that is increased by 0.11V (>the aforementioned difference 0.1V) from the power supply voltage 1.0V at the cell of the previous stage is impressed at a cell of the later cell, and an input voltage that is equal to or higher than 1.0 V is determined as being “high”. Because the power supply voltage is 1.0V at the cell of the previous stage, no voltage that exceeds 1.0V is inputted into the cell of the later stage. Therefore, even when “high” is outputted at the cell of the previous stage, the cell of the later stage does not determines as being “high”.

On the other hand, as illustrated on the right side of FIG. 16, the power supply voltage at the cell of the later stage is 1.05V that is higher than the power supply voltage 1.0V at the cell of the previous stage by 0.05V (<the aforementioned difference 0.1V), and when the input voltage is equal to or higher than 0.95V, the cell of the later stage determines as being “high”. Because the power supply voltage at the cell of the previous stage is 1.0V, the voltage of about 1.0V is outputted, when the output from the cell of the previous stage is “high”. Therefore, when the voltage that is equal to or higher than 0.95V is inputted into the cell of the later stage, the output “high” of the previous stage is also determined as being “high” at the later stage. Thus, the voltage that is less than the difference between the power supply voltage and the threshold voltage by which the input voltage is determined as being “high” is used as the designated voltage width. In other words, it becomes possible to obtain the effect of the power consumption reduction while operating logically accurately. However, 1.0V is an example, and other voltages may be used depending on a kind of device or technology. Therefore, the designated voltage width may be changed depending on the power supply voltage and a kind of device or technology.

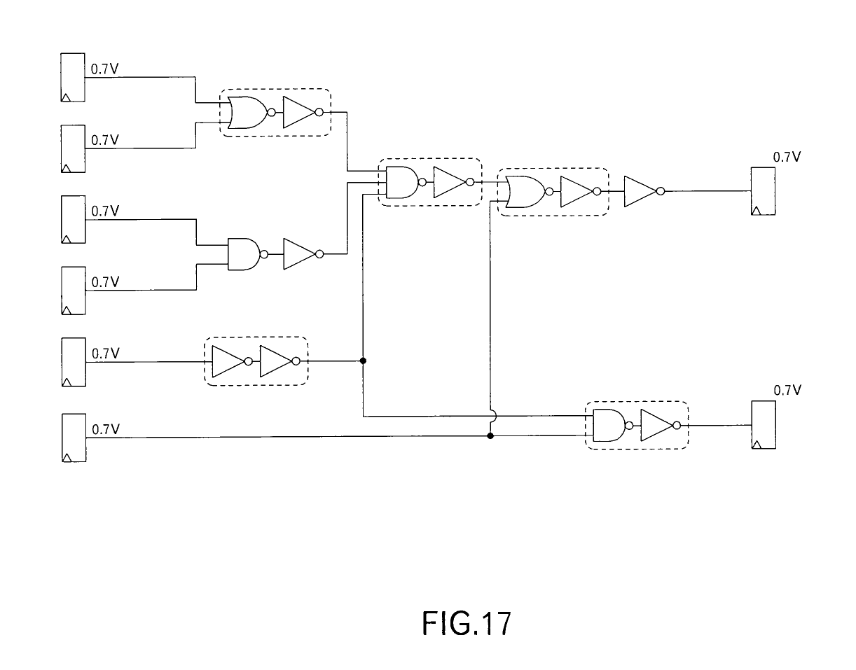

For example, in case of the changed circuit as illustrated in FIG. 14, firstly, a register is identified as the cell satisfying the predetermined condition, the lowest guaranteed operational voltage 0.7V is set to the register as a setting for the operation at the low-voltage and low-frequency (FIG. 17).

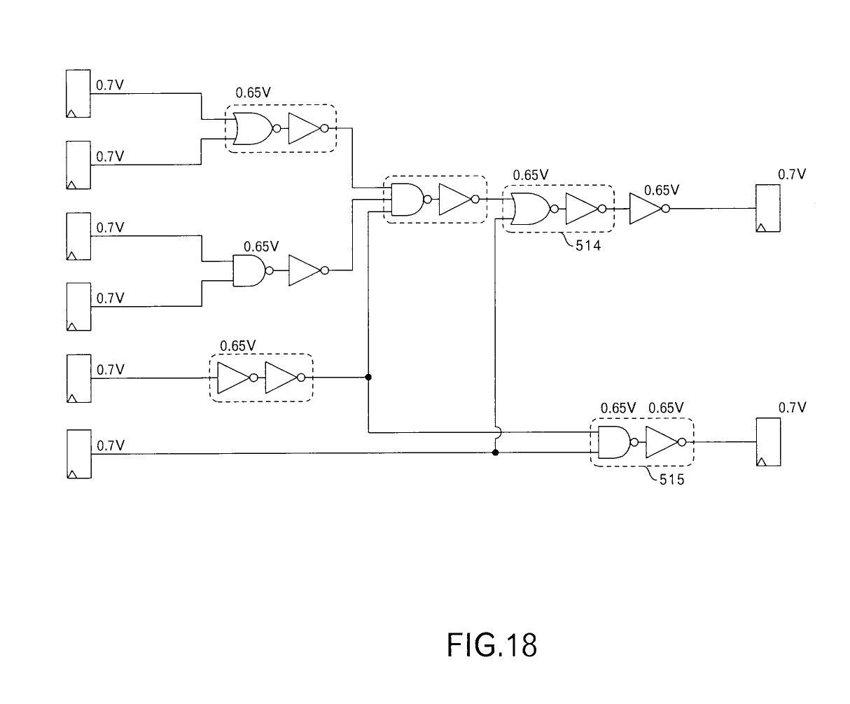

Next, each path extending from each register is traced one stage of the cell or sub-cell, and the power supply voltage 0.65V that is lowered by the designated voltage width 0.05V like in the aforementioned example is set to the cell or sub-cell of the trace destination. As illustrated in FIG. 18, the trace is performed from the register at the left edge by one next cell or sub-cell of the right side, and the trace is also performed from the register at the right edge by one next cell or sub-cell of the left side. The NOR circuit in the sub-cell elements 514 (or serially-connected elements) is a sub-cell that is provided near the right side in FIG. 18, and is also the sub-cell that is provided at the first stage from the register at the left edge of the lowest stage. Therefore, 0.65V is set to the NOR circuit.

Moreover, as for a trace stop condition of the path, there is a condition that the trace is stopped when the power supply voltage has already been set to the next cell or sub-cell on the path. Because the power supply voltage has already been set to an inverter that is a sub-cell next to a NAND circuit within the sub-cell elements 511, for which the power supply voltage has already been set along a path from the register at the left edge of the lowest stage, along a path from a register at the right edge of the lowest stage, the traces of the paths in both direction end.

Next, shifting to the next cell or sub-cell on each path, the power supply voltage 0.60V that is further lowered by the designated voltage width 0.05V is set. Note here that the next cell or sub-cell of the NOR circuit within the sub-cell elements 514 includes not only an inverter within the sub-cell elements 514 but also an inverter within the sub-cell elements 513. The same power supply voltage is set to the inverter within the sub-cell elements 514 along the path from the register at the right edge, however, the trace on this path ends here. On the other hand, the trace from the inverter within the sub-cell elements 513 continues.

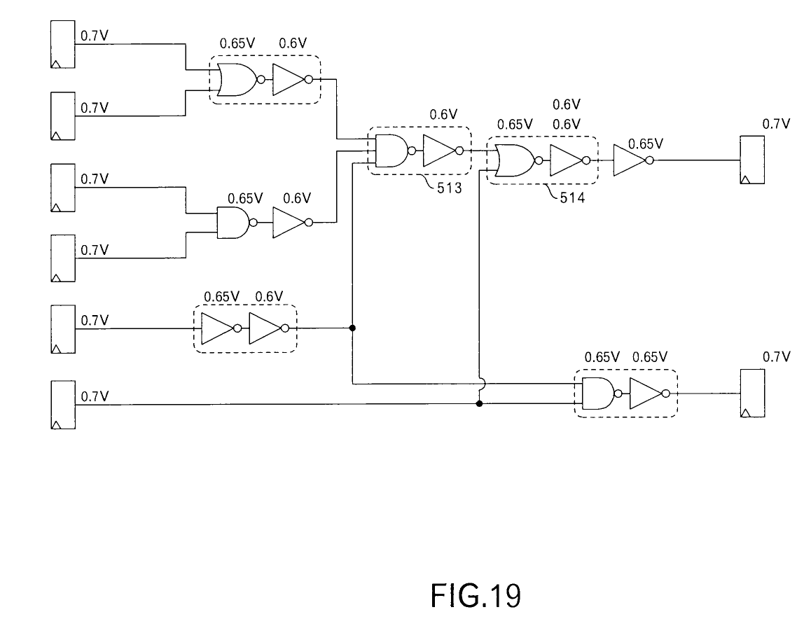

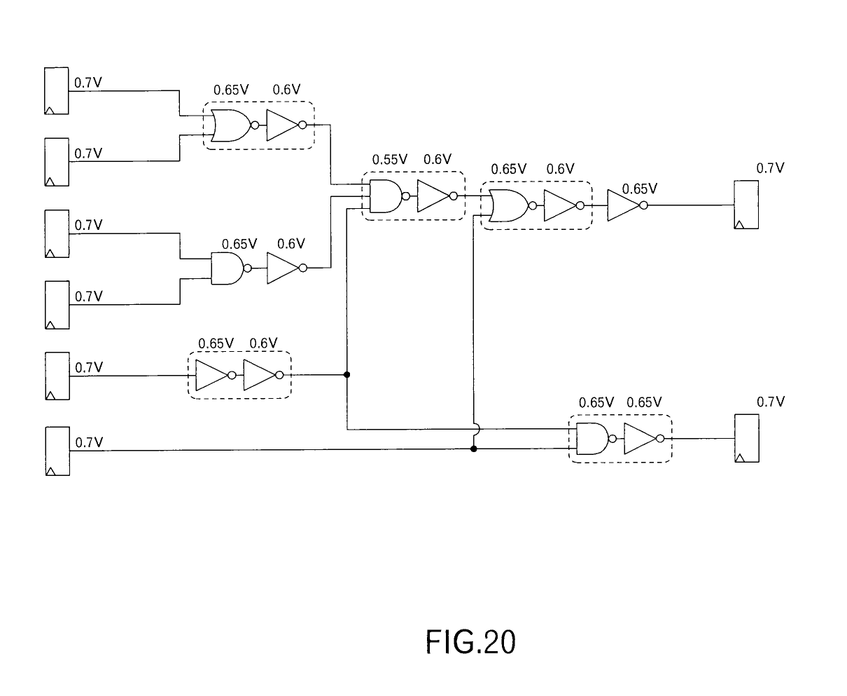

Furthermore, shifting to the next cell or sub-cell on each path, the power supply voltage 0.55V, which is further lowered by 0.05V, is set. In an example of FIG. 19, the cell or sub-cell for which the power supply voltage has not been set is only a NAND circuit within the sub-cell elements 513, and 0.55V is simultaneously set to this NAND circuit for four paths, and the path trace is completed. Then, a setting state of the power supply voltage is obtained as illustrated in FIG. 20.

Typically, the number of power supply lines that can be prepared is restricted, and it is possible to lower the power supply voltage during the path trace n times (n is equal to (the number of power supply lines that can be prepared −1)). In addition, even when the power supply lines can be prepared, the power supply voltage that is lower than the lowest guaranteed operational voltage of the combinational circuits is not set.

Such data for the setting state of the power supply voltage is stored in the changed circuit data storage unit 104. The processing may be completed at this stage.

Next, the non-critical-path processing unit 108 outputs circuit data and the like, which is stored in the changed circuit data storage unit 104, to the analyzer 110 to cause the analyzer 110 to execute a processing for estimating the delay and consumed power (step S7). As described above, the analyzer 110 is an existing tool, and the description of the specific processing contents will be omitted here. As for the delay estimation, Static Timing Analysis tool is typically used. A product such as “PrimeTime” supplied by Synopsys or “Encounter Timing System” supplied by Cadence may be used. The former product has a function for estimating the consumed power.

The estimated delay value is calculated for each path between cells whose lowest guaranteed operational voltage satisfies the predetermined condition, such as between registers. Moreover, when the non-critical-path processing unit 108 receives an estimation result of the delay for each path and estimation result of the consumed power, the non-critical-path processing unit 108 stores the received data into the data storage unit 109. A difference (i.e. delay margin) between the estimated delay value and a preset reference value may be calculated.

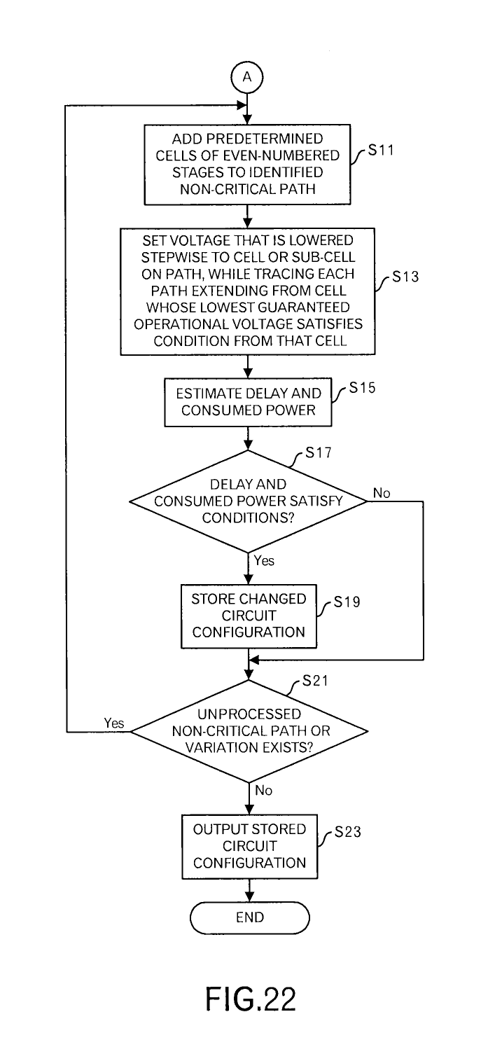

Moreover, the non-critical-path processing unit 108 identifies a critical path whose estimated delay value is the maximum or similar to the maximum, based on the estimated delay values of the respective paths, and identifies non-critical paths that are other than the critical path (step S9). Then, the processing shifts to a processing flow in FIG. 22 through a terminal A.

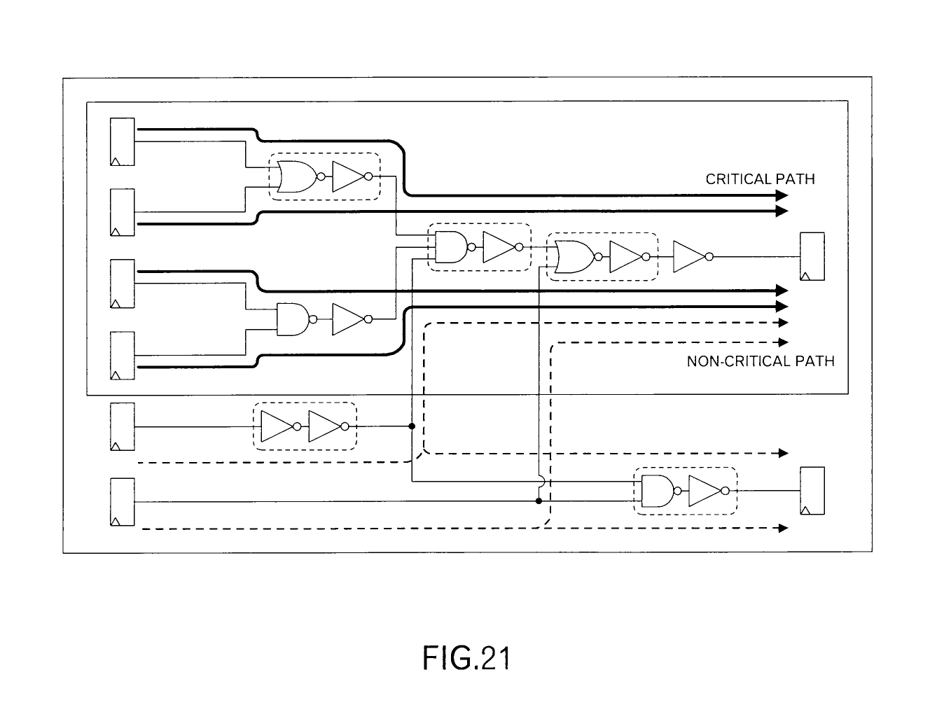

In the aforementioned circuit example, the path (solid line) relating to the register positioned on the top stage of the upper left in FIG. 21 is identified as the critical path, and paths illustrated by the dotted lines are identified as the non-critical path.

Shifting to the explanation of the processing in FIG. 22, the non-critical-path processing unit 108 inserts inverters or buffers of even-numbered stages into the identified non-critical path of the changed circuit stored in the changed circuit data storage unit 104 (step S11). When there are plural non-critical paths, one non-critical path is selected. The number of stages of the inverters or buffers to be inserted is set so that the number of stages in the non-critical path after inserting the inverters or the like does not exceed the number of stages in the critical path. The data of the changed circuit is stored, for example, in the data storage unit 109.

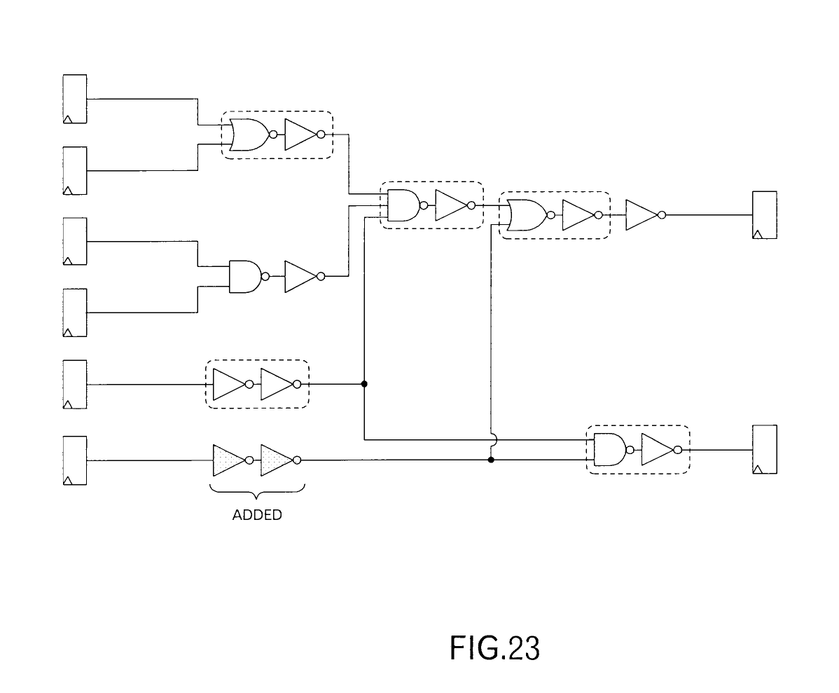

For example, an example in which two inverters are inserted in the aforementioned circuit example is illustrated in FIG. 23. In an example of FIG. 23, two inverters are inserted in the non-critical path that extends from a register that is positioned at the second stage from the lowest stage in the lower left. Because the number of stages of cells is lesser in this non-critical path, the power supply voltage is early set for the sub-cells in the sub-cell elements 514 that are positioned at the relatively right side as illustrated in FIG. 18.

Then, the non-critical-path processing unit 108 causes the voltage setting unit 107 to perform the voltage setting processing for the circuit after inserting the inverters or the like in the non-critical path (step S13). In other words, while the voltage setting unit 107 traces each path extending from a cell whose lowest guaranteed operational voltage satisfies the predetermined condition, from that cell, the voltage setting unit 107 sets a lowered voltage for each cell or sub-cell on each path. The basic operation is the same as that at the step S5, and the circuit configuration to be processed is different.

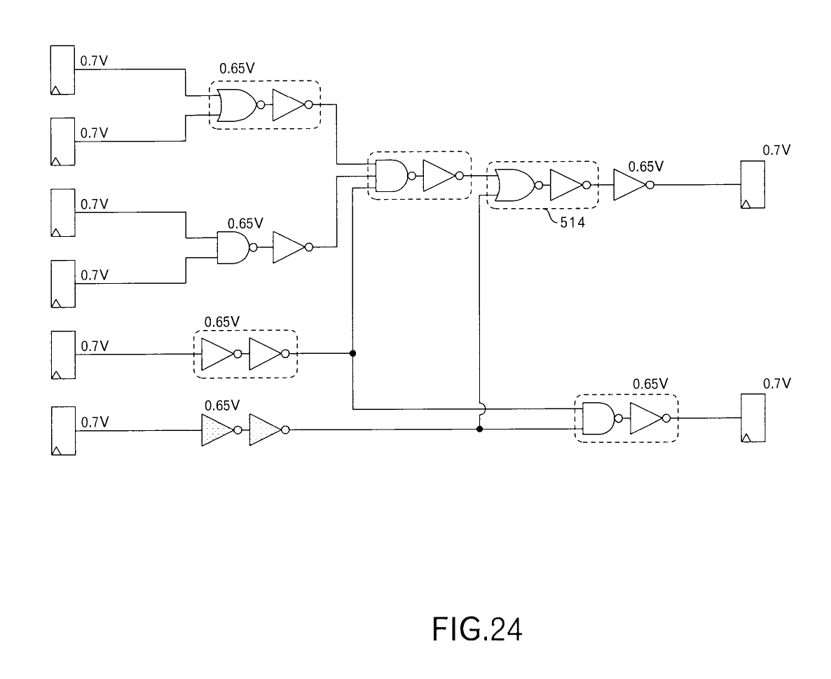

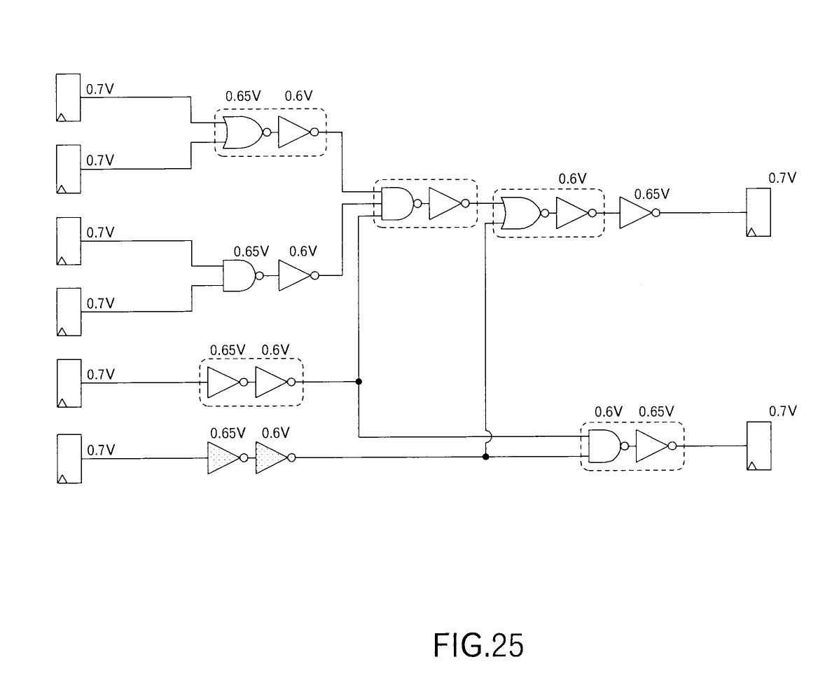

In case of the circuit as illustrated in FIG. 23, the voltages are set at the first step as illustrated in FIG. 24. Because of the two inverters that are inserted into the path at the lowest stage, no voltage is set for the sub-cell elements 514. At the next step, voltages as illustrated in FIG. 25 are set. In case where the insertion of the inverters or the like is not performed, there is only one cell for which the voltage is not set at the time point when the second step is completed as illustrated in FIG. 19. However, three cells for which the voltage has not been set remain in FIG. 25.

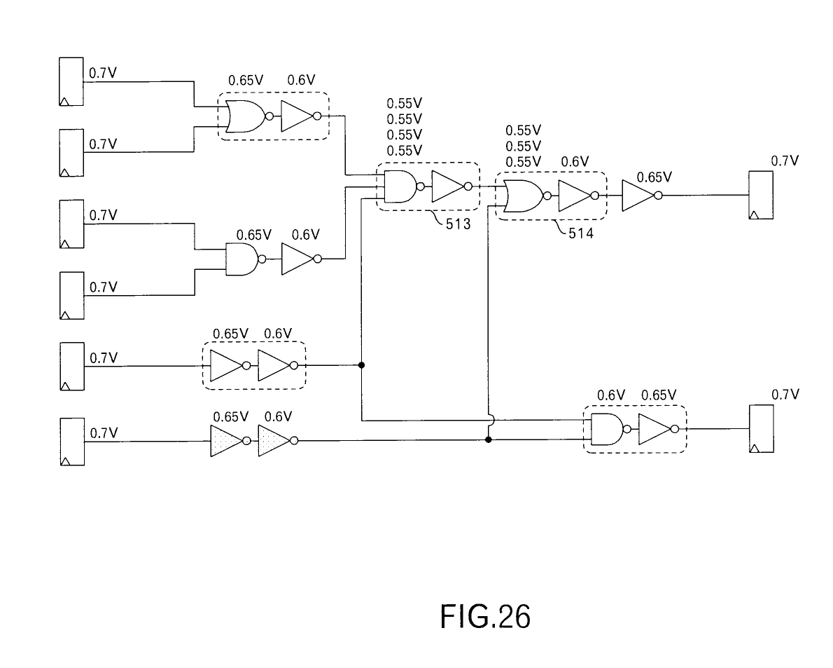

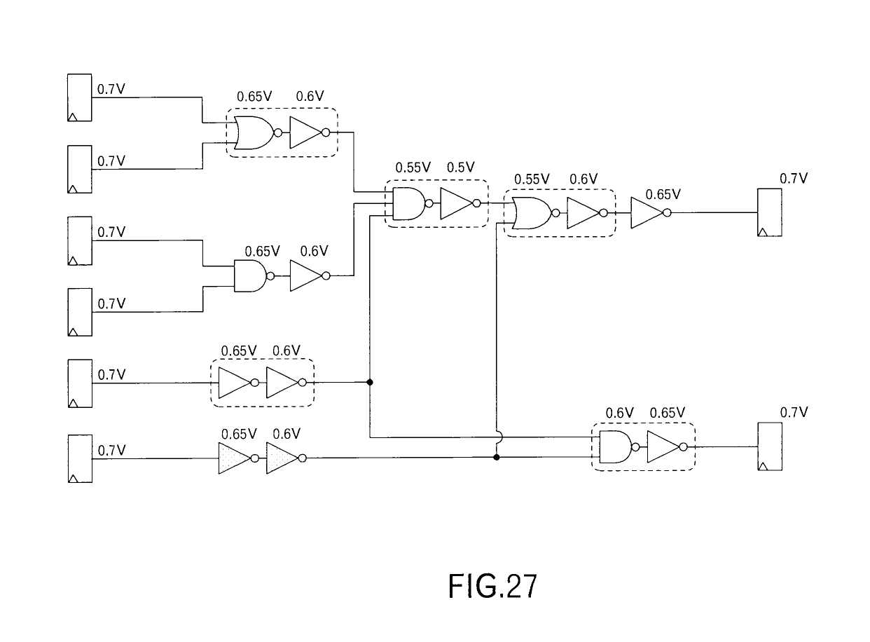

At the third step, voltages are set as illustrated in FIG. 26. 0.55V is simultaneously set to the NAND circuit within the sub-cell elements 513 from four paths, and 0.55V is simultaneously set to the NOR circuit within the sub-cell elements 514 from three paths. At this stage, one cell for which no voltage is set remains. In other words, when no inverter or the like is inserted as illustrated in FIG. 20, the lowest set voltage is 0.55V. However, when inserting the inverters or the like as described above, the lowest set voltage becomes 0.5V as illustrated in FIG. 27.

The non-critical-path processing unit 108 receives data for the power supply voltage setting state from the voltage setting unit 107, and stores the received data into the data storage unit 109, for example.

After that, the non-critical-path processing unit 108 outputs data for the changed circuit, which is stored in the data storage unit 109 and data for the power supply voltage setting state to the analyzer 110 to cause the analyzer 110 to estimate the delay and consumed power (step S15). The non-critical-path processing unit 108 receives the results of the delay and consumed power from the analyzer 110, and stores the received data into the data storage unit 109.

Then, the non-critical-path processing unit 108 determines whether or not the estimation results of the delay and consumed power satisfy predetermined conditions (step S17). The predetermined conditions include a condition that the estimation result of the consumed power is less than the minimum value of the consumed power, which was estimated up to this time. Moreover, as for the delay, the predetermined conditions include a condition that the insertion of the inverters or the like does not badly affect the delay of the critical path, in other words, the delay of the critical path does not increase. Not only the condition for the critical path but also a condition for the non-critical path may be set as the condition for the delay. For example, a condition may be added that the delay for the non-critical path does not increase by a predetermined ratio or more or by a predetermined period or more.

When the estimation results of the delay and consumed power do not satisfy the predetermined condition, the processing shifts to the step S21 because no inverter is inserted.

On the other hand, when the estimation results of the delay and consumed power satisfy the predetermined condition, the non-critical-path processing unit 108 stores data of the circuit configuration after inserting the inverters or the like this time (which includes data for the power supply voltage setting state) into the changed circuit data storage unit 104 (step S19). When the data of the circuit configuration after inserting the inverters or the like has already been stored in the changed circuit data storage unit 104, the conventional data of the circuit configuration is deleted, and data of the circuit configuration after inserting the inverters or the like this time is stored. However, data may be additionally stored so that the data that was lastly stored can be identified.

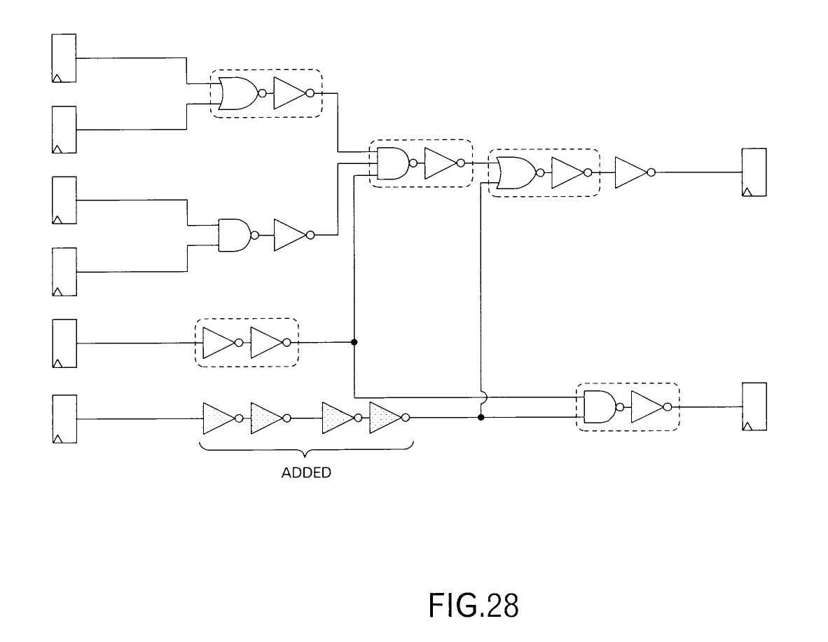

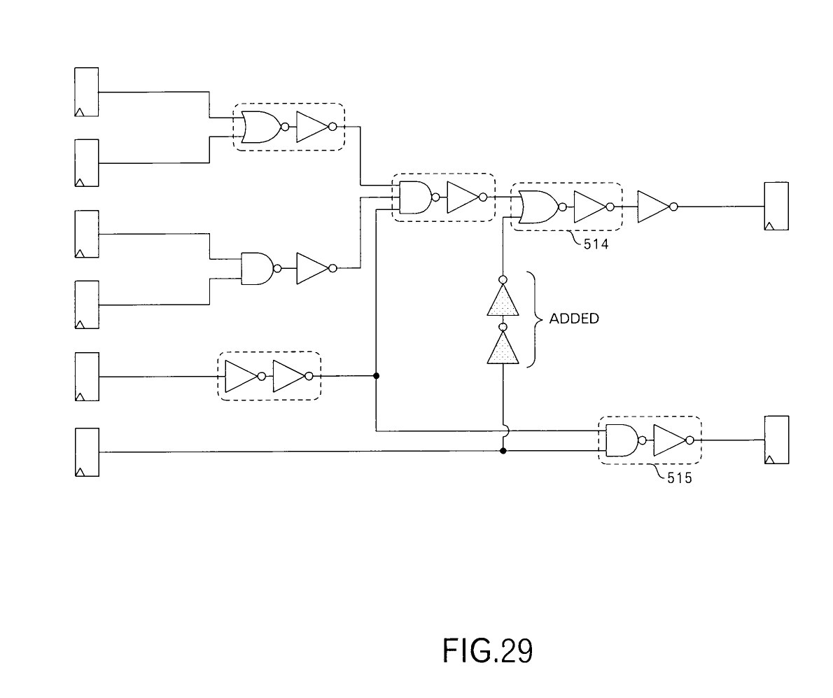

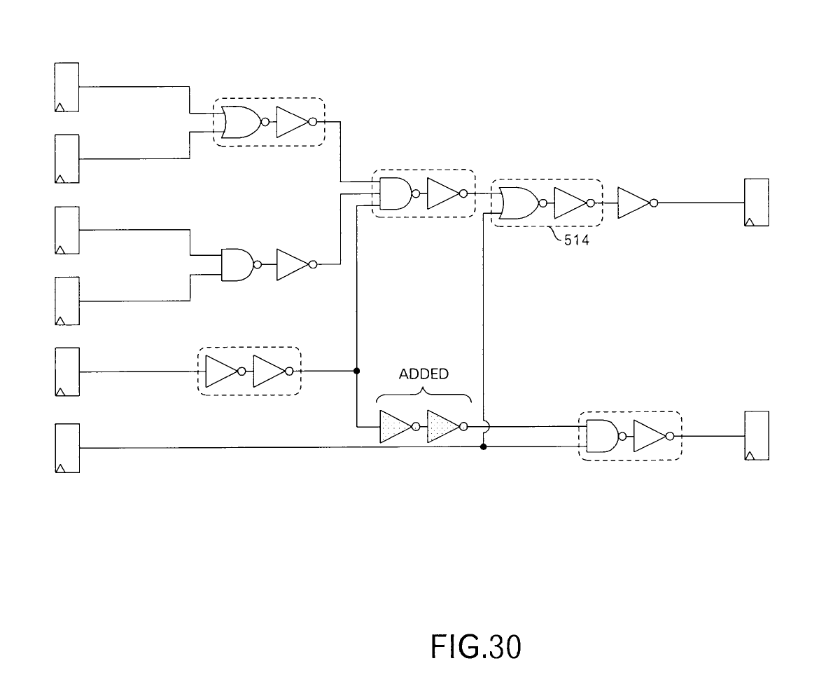

Then, the non-critical-path processing unit 108 determines whether or not there is an unprocessed variation for an unprocessed non-critical path, the number of inverters to be inserted, the position at which inverters are inserted or the like (step S21). In the aforementioned processing, two inverters were inserted. However, as illustrated in FIG. 28, four inverters may be inserted, for example, and the position at which the inverters are inserted may be changed as illustrated in FIG. 29. When the inverters are inserted at the position as illustrated in FIG. 29, the effect with respect to the sub-cell elements 514 is maintained. However, the effect with respect to the sub-cell elements 515 is lost. Therefore, the power consumption may not be reduced. Furthermore, as illustrated in FIG. 30, two inverters may be inserted for the different non-critical path. In an example of FIG. 30, there is not effect with respect to the sub-cell elements 514. Therefore, the effect of the power consumption reduction may not be obtained. Thus, the estimation of the delay and consumed power is carried out while changing the circuit for each variation obtained according to a predetermined rule.

When there is an unprocessed variation or unprocessed non-critical path, the processing returns to the step S11. On the other hand, when there is no unprocessed non-critical path or unprocessed variation, the output unit 111 outputs the circuit data without insertion of the inverters or the like, which is stored, for example, in the changed circuit data storage unit 104, and circuit data whose consumed power is least and that includes inserted inverters or the like to a display device or the like (step S23). When it is not possible to reduce the consumed power even when inserting the inverters or the like, only the circuit data without inserting the inverters or the like is outputted. The data of the consumed power may be stored in the changed circuit data storage unit 104 and may be outputted together. Moreover, only the circuit data that includes the insertion of the inverters or the like may be outputted.

By carrying out such a processing, it is possible to further reduce the consumed power.

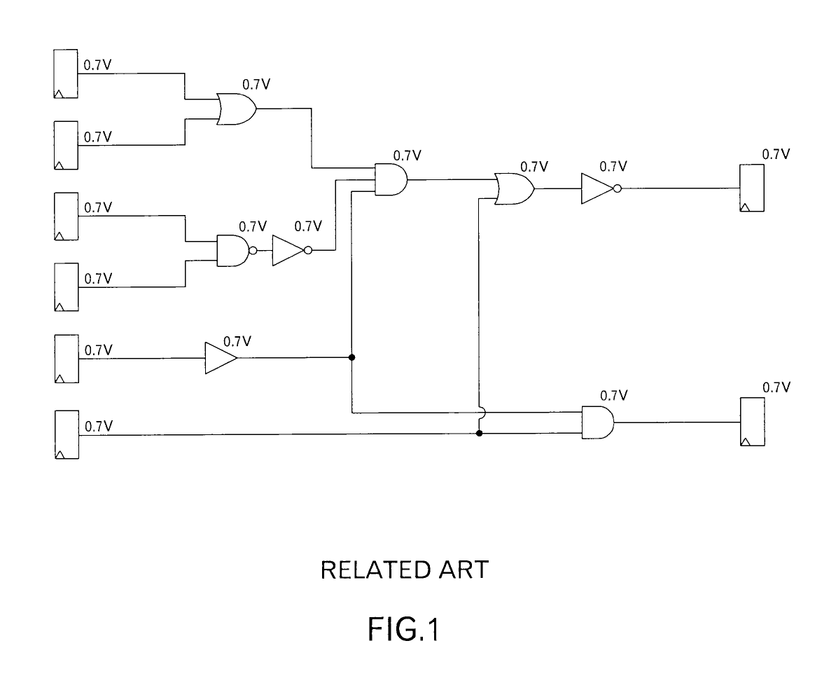

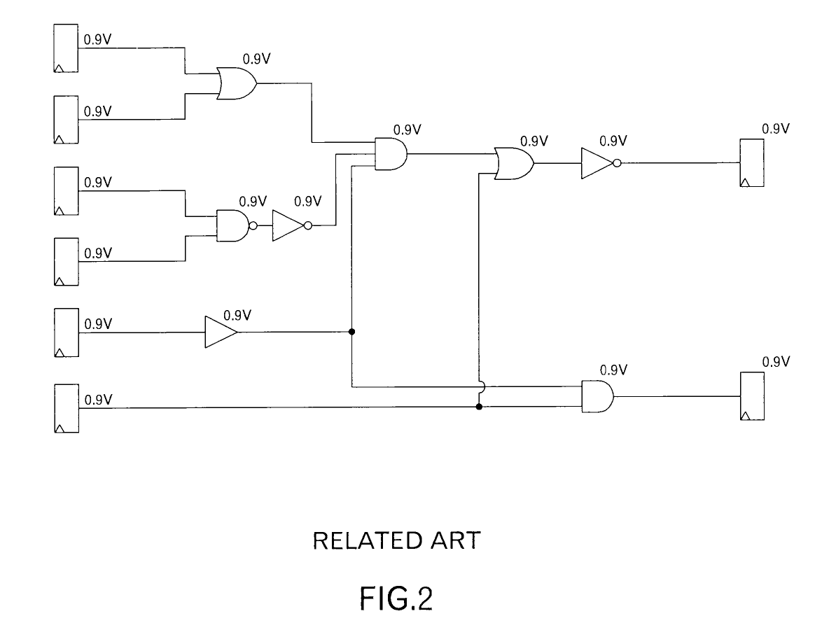

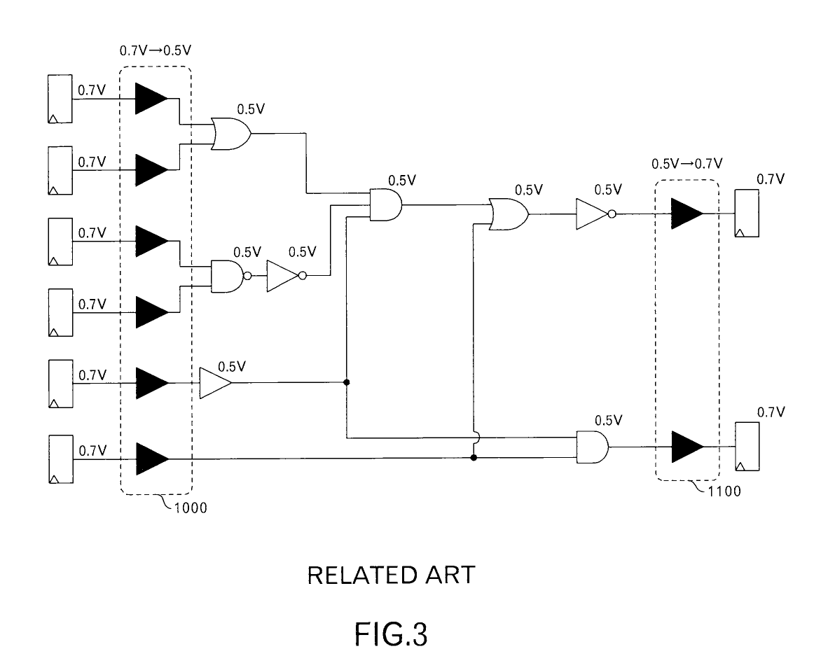

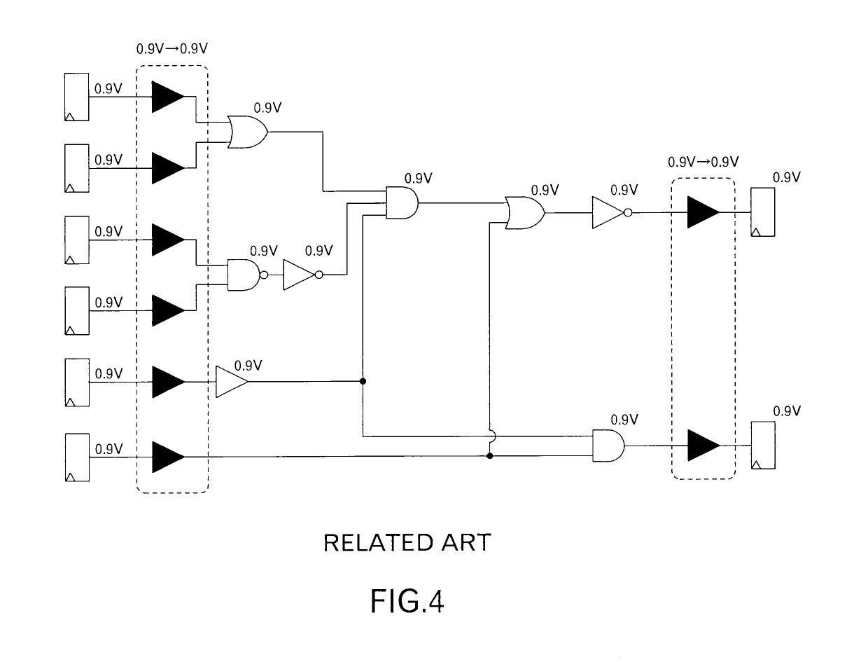

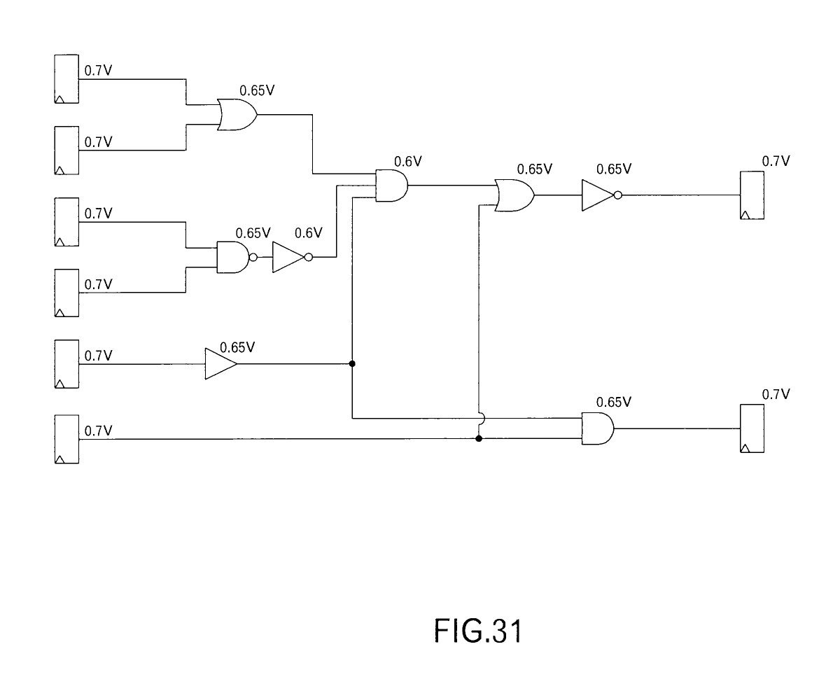

In the aforementioned example, when this embodiment is not applied as illustrated in FIG. 1 and the power supply voltage is simply lowered to the lowest guaranteed operational voltage 0.7V of the register, the consumed power is estimated as being 492.9 [uW]. On the other hand, when the processing of the step S5 is carried out without performing the cell division, the power supply voltages are set as illustrated in FIG. 31. In such a power supply voltage setting state, the consumed power is estimated as being 482.2 [uW]. Furthermore, when the processing in this embodiment is ended at the step S5, in other words, when the cell division is merely carried out (FIG. 20), the consumed power is estimated as being 476.9 [uW]. When the level shifters are introduced as illustrated in FIG. 3, the consumed power is estimated as being 568.9 [uW]. Thus, even when the processing up to the step S5 is executed, the sufficient effect can be obtained. Furthermore, when the inverters are inserted as illustrated in FIG. 27, the consumed power is estimated as being 476.5 [uW], and the effect of the insertion of the inverters is better than the case where the processing up to the step S5 is carried out.

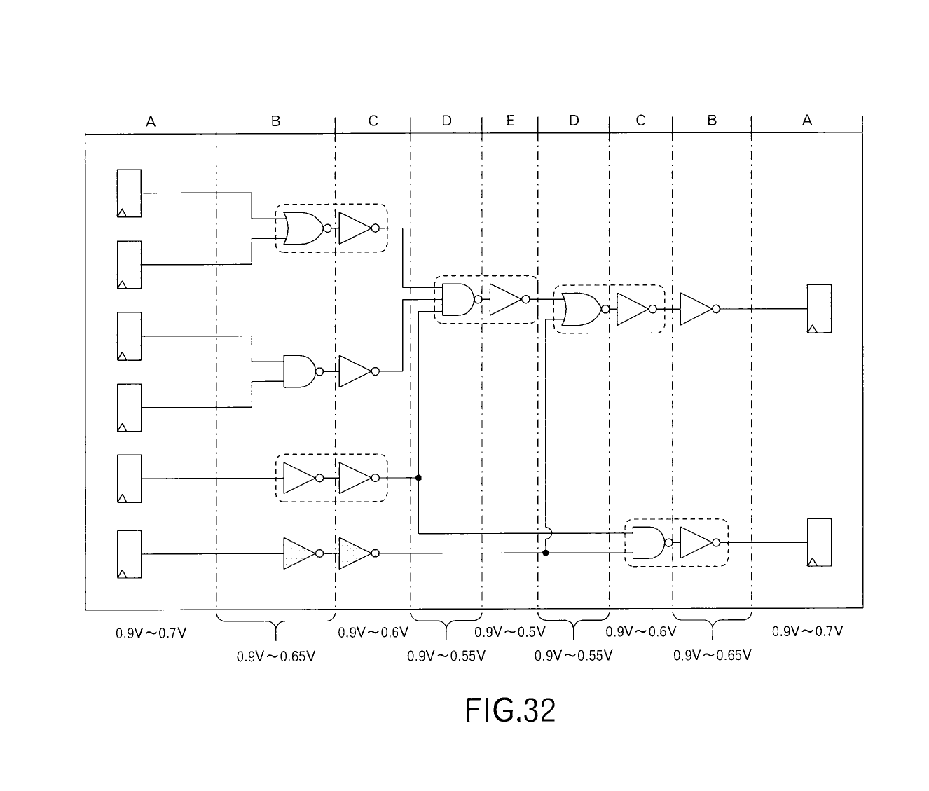

The setting state of the power supply voltages, which has been explained, represents the setting state of the power supply voltages at the low-voltage operation. Moreover, the setting state of the power supply voltages also represents power line separation, and as illustrated in FIG. 27, when the power supply voltages from 0.7 V to 0.55 V are used, the setting state represents that five power supply lines are used. In other words, as schematically illustrated in FIG. 32, the cells and sub-cells are divided into zone A whose lowest voltage is 0.7 V, zone B whose lowest voltage is 0.65 V, zone C whose lowest voltage is 0.6 V, zone D whose lowest voltage is 0.55 V, and zone E whose lowest voltage is 0.5 V. Here, because the power supply voltage can be changed for the same power supply line, 0.9 V is impressed to the same power supply line at the high-voltage and high-speed operation. Therefore, in the zone A, the power supply voltage changes between 0.7 V and 0.9 V, in the zone B, the power supply voltage changes between 0.65 V and 0.9 V, in the zone C, the power supply voltage changes between 0.6 V and 0.9 V, in the zone D, the power supply voltage changes between 0.55 V and 0.9 V, and in the zone E, the power supply voltage changes between 0.5 V and 0.9 V.

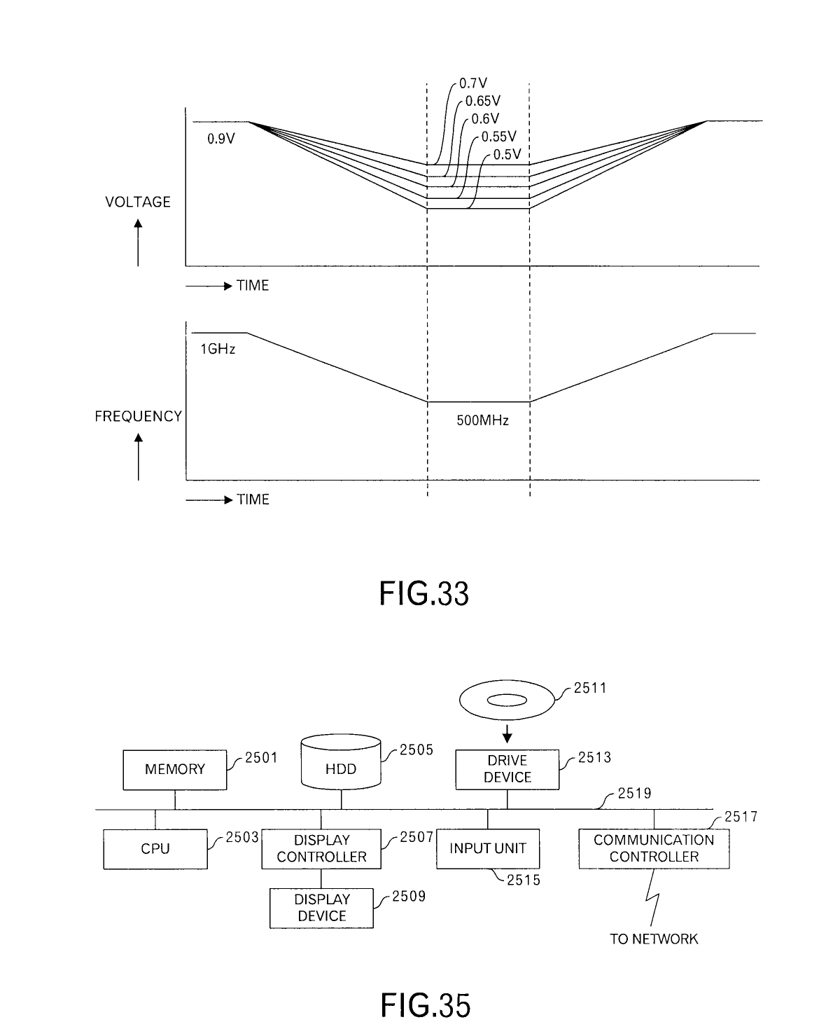

More specifically, the temporal change of the power supply voltage and temporal change of the frequency will be explained by using FIG. 33. The lower stage of FIG. 33 represents the temporal change of the frequency, and in case of the high-speed operation, the frequency is 1 GHz, and in case of the low-speed operation, the frequency is 500 MHz. The frequency gradually decreases or increases between the high-speed operation and the low-speed operation. The upper stage of FIG. 33 represents the temporal change of the power supply voltage, and the change of the power supply voltage is different for each zone illustrated in FIG. 32. In case of the zone A, the power supply voltage is lowered up to 0.7 V at the lowest, however, in case of the zone E, the power supply voltage is lowered up to 0.5 V at the lowest. Thus, the power supply voltage changes between the lowest voltage and the highest voltage for each zone depending on the operation frequency. By employing this embodiment, much more cells operate at much lower voltages. Therefore, the consumed power is reduced.

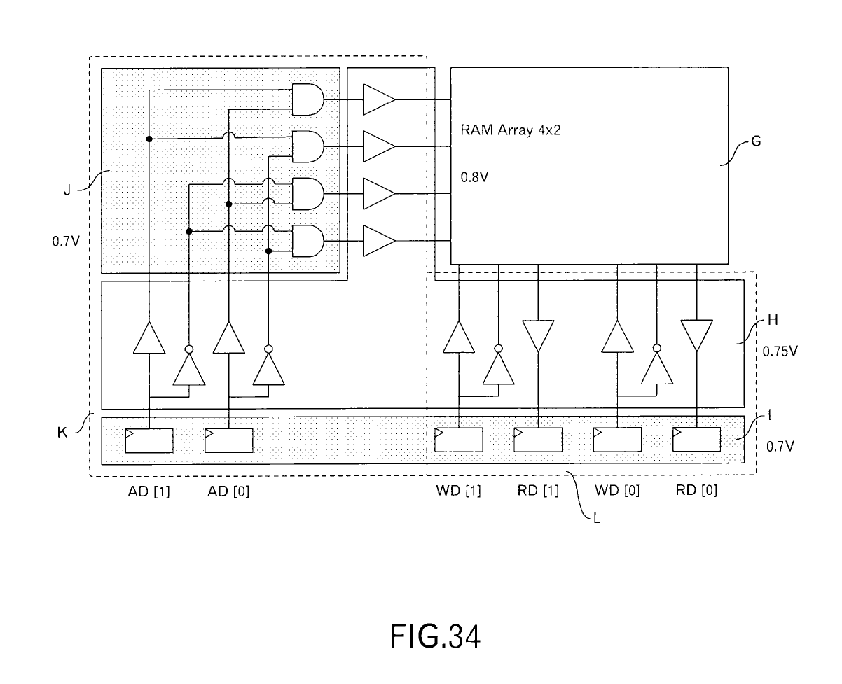

Moreover, this embodiment can be applied to a case where not only the register as described above but also RAM or the like is included. FIG. 34 includes an example that a macro of RAM is divided into plural sub-elements. In an example of FIG. 34, the macro of RAM includes a RAM array, an address decoder K, a write data driver and read data buffer L. In the address decoder K, the registers are provided on the lower side, and in the write data driver and read data buffer L, the registers are also provided on the lower side. 0.8 V is set as the lowest guaranteed operational voltage to the RAM array, and 0.7 V is set as the lowest guaranteed operational voltage to the registers. Then, other portions are divided into the sub-elements whose power supply can be split like the cell division. So, as illustrated in FIG. 34, the other portions are divided into zone G of the RAM array to which the power supply voltage 0.8 V is set, zone I of the registers to which the power supply voltage 0.7 V is set, zone H including the driver, to which the power supply voltage 0.75 V is set, and zone J including an AND circuit of the address decoder, to which the power supply voltage 0.7 V is set. By carrying out such a processing, even in case of a circuit such as the macro including plural circuit elements, cells or the like, it is possible to reduce the power consumption.

Although the embodiment of this invention was explained, this invention is not limited to this embodiment. For example, as for the processing flow, as long as the processing results do not change, steps may be exchanged or plural steps may be executed in parallel.

Furthermore, the functional block diagram of the design support apparatus 100 illustrated in FIG. 5 is a mere example, and does not correspond to a program module configuration. The data storage mode illustrated above is a mere example.

In addition, an example that variations are automatically detected after finding the non-critical paths was explained, however, in response to an instruction from a user, the number of inverters to be inserted to the non-critical path or position of the inverters may be identified.

In addition, the design support apparatus 100 is a computer device as shown in FIG. 35. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as illustrated in FIG. 35. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiments are outlined as follows:

A design support method relating to this embodiment includes: (A) identifying an element of a type that is predetermined as being capable of dividing into plural sub-elements that connect with different power supplies from among plural elements included in a circuit; (B) dividing the identified element into the plural sub-elements that are predetermined for the type of the identified element; (C) while tracing (e.g. element-by-element) each path extending between elements that satisfy a predetermined condition for a guaranteed operational voltage by which an operation of an element is guaranteed, from the elements that satisfy the predetermined condition, setting a power supply voltage that is lowered along with the tracing, to elements or sub-elements on the path.

According to this method, no level shifter is introduced uniformly. Therefore, no delay is increased even in case of the high-voltage and high-speed driving, and the power reduction is enhanced because the setting of the further lowered voltages is possible even in case of the low-voltage and low-speed driving.

Moreover, in the aforementioned setting, the tracing of the path may be stopped when an element or sub-element to which a power supply voltage has been set is detected on the path extending between the elements that satisfy the aforementioned condition. In addition, in the aforementioned setting, a power supply voltage that is equal to or higher than a predetermined lower limit voltage may be set to the elements or sub-elements on the path. Furthermore, in response to detecting that the number of types of power supply voltages to be set reaches an upper limit number, change of the power supply voltage is stopped in the tracing of the path after the detecting. By carrying out the aforementioned processing, the power supply voltages can be appropriately and efficiently set.

Furthermore, the aforementioned design support method may further include: (D) inserting inverters or buffers on a non-critical path that is identified based on delay data of each path, which is obtained based on a first state of the power supply voltages set in the aforementioned setting; and (E) while tracing each path extending between elements that satisfy a predetermined condition for a guaranteed operational voltage by which an operation of an element is guaranteed and is included in the circuit after the inserting, from the elements that satisfy the predetermined condition, setting a power supply voltage that is lowered along with the tracing, to elements or sub-elements on the path; and (F) when a consumed power of the circuit, which is obtained based on a second state of the power supply voltages set to the circuit after the inserting, is less than a consumed power of the circuit, which is obtained based on the first state, and delay data that is obtained based on the second state satisfies a second predetermined condition, storing data of a configuration of the circuit after the inserting and data of the second state of the power supply voltages. According to this processing, the delay for the non-critical path increases, however, the setting of the power supply voltages, which may cause the reduction of the power consumption, may be made.

A design support method relating to a second aspect of the embodiments includes: (A) dividing an circuit element that is included in a circuit to be designed and is provided on a path that connects between memory circuits into a plurality of circuit elements, based on information to identify a circuit element that can be divided into plural circuit elements among circuit elements on the path, wherein the information is stored in a storage unit; (B) tracing the path from the memory circuits; and (C) upon detecting that a circuit element whose guaranteed operation voltage by which an operation is guaranteed satisfies a predetermined voltage condition exists on the path, setting a new power supply voltage that is lowed by a predetermined voltage from a voltage, which is currently set, to the circuit element whose guaranteed operation voltage satisfies the predetermined voltage condition.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a process, the process comprises:
dividing an circuit element that is included in a circuit to be designed and is provided on a path that connects between memory circuits into a plurality of circuit elements, based on information concerning circuit elements that can be divided into plural circuit elements, wherein the information is stored in a storage unit;
tracing the path from the memory circuits; and
during the tracing, setting a new power supply voltage that is lowed by a predetermined voltage from a voltage, which was set immediately before, to a traced circuit element, which is provided on the path and satisfies a predetermined condition concerning a predetermined lower limit voltage of the traced circuit element.

2. The computer-readable, non-transitory storage medium as set forth in claim 1, wherein the predetermined condition is a condition that the new power supply voltage is equal to or higher than the predetermined lower limit voltage of the traced circuit element.

3. The computer-readable, non-transitory storage medium as set forth in claim 1, wherein the tracing is stopped upon detecting a circuit element to which a power supply voltage has been set.

4. The computer-readable, non-transitory storage medium as set forth in claim 1, wherein the process further comprises:
after a number of types of power supply voltages that have been set reaches a predetermined number, setting the voltage, which was set immediately before, to a traced circuit element.

5. The computer-readable, non-transitory storage medium as set forth in claim 1, wherein the dividing, the tracing and the setting are performed for a plurality of paths that connects between memory circuits in the circuit to be designed, and
the process further comprises:
inserting a circuit element into a second path that is identified among the plurality of paths based on delay information of the circuit to be designed after the setting;
executing the tracing and the setting for the second path; and
upon detecting that a condition that a consumed power obtained based on a first power supply state of the circuit to be designed after the executing is lower than a consumed power obtained based on a second power supply state of the circuit to be designed after the setting and delay information of the circuit to be designed after the inserting satisfies a second predetermined condition, storing the circuit to be designed after the inserting.

6. A design support method, comprising:
dividing, by using a computer, an circuit element that is included in a circuit to be designed and is provided on a path that connects between memory circuits into a plurality of circuit elements, based on information concerning circuit elements that can be divided into plural circuit elements, wherein the information is stored in a storage unit;
tracing, by using the computer, the path from the memory circuits; and
during the tracing, setting, by using the computer, a new power supply voltage that is lowed by a predetermined voltage from a voltage, which was set immediately before, to a traced circuit element, which is provided on the path and satisfies a predetermined condition concerning a predetermined lower limit voltage of the traced circuit element.

7. The design support method as set forth in claim 6, wherein the predetermined condition is a condition that the new power supply voltage is equal to or higher than the predetermined lower limit voltage of the traced circuit element.

8. The design support method as set forth in claim 6, wherein the tracing is stopped upon detecting a circuit element to which a power supply voltage has been set.

9. The design support method as set forth in claim 6, wherein the process further comprises:
after a number of types of power supply voltages that have been set reaches a predetermined number, setting the voltage, which was set immediately before, to a traced circuit element.

10. The design support method as set forth in claim 6, wherein the dividing, the tracing and the setting are performed for a plurality of paths that connects between memory circuits in the circuit to be designed, and
the design support method further comprises:
inserting a circuit element into a second path that is identified among the plurality of paths based on delay information of the circuit to be designed after the setting;
executing the tracing and the setting for the second path; and
upon detecting that a condition that a consumed power obtained based on a first power supply state of the circuit to be designed after the executing is lower than a consumed power obtained based on a second power supply state of the circuit to be designed after the setting and delay information of the circuit to be designed after the inserting satisfies a second predetermined condition, storing the circuit to be designed after the inserting.

11. A design support apparatus, comprising:
a memory;
a processor configured to use the memory and execute a process, the process comprising:
dividing an circuit element that is included in a circuit to be designed and is provided on a path that connects between memory circuits into a plurality of circuit elements, based on information concerning circuit elements that can be divided into plural circuit elements, wherein the information is stored in a storage unit;
tracing the path from the memory circuits; and
during the tracing, setting a new power supply voltage that is lowed by a predetermined voltage from a voltage, which was set immediately before, to a traced circuit element, which is provided on the path and satisfies a predetermined condition concerning a predetermined lower limit voltage of the traced circuit element.

12. The design support apparatus as set forth in claim 11, wherein the predetermined condition is a condition that the new power supply voltage is equal to or higher than the predetermined lower limit voltage of the traced circuit element.

13. The design support apparatus as set forth in claim 11, wherein the tracing is stopped upon detecting a circuit element to which a power supply voltage has been set.

14. The design support apparatus as set forth in claim 11, wherein the process further comprises:
after a number of types of power supply voltages that have been set reaches a predetermined number, setting the voltage, which was set immediately before, to a traced circuit element.

15. The design support apparatus as set forth in claim 11, wherein the dividing, the tracing and the setting are performed for a plurality of paths that connects between memory circuits in the circuit to be designed, and
the process further comprises:
inserting a circuit element into a second path that is identified among the plurality of paths based on delay information of the circuit to be designed after the setting;
executing the tracing and the setting for the second path; and
upon detecting that a condition that a consumed power obtained based on a first power supply state of the circuit to be designed after the executing is lower than a consumed power obtained based on a second power supply state of the circuit to be designed after the setting and delay information of the circuit to be designed after the inserting satisfies a second predetermined condition, storing the circuit to be designed after the inserting.
